(19) United States
(12) Patent Application Publication
(10) Pub. No.: US 2009/0311578 A1
(43) Pub. Date: Dec. 17, 2009

(54) WATER REPELLENT CATALYST LAYER FOR POLYMER ELECTROLYTE FUEL CELL AND MANUFACTURING METHOD FOR THE SAME

(75) Inventors: Shinnosuke Koji, Kawasaki-shi (JP); Kazuya Miyazaki, Tokyo (JP); Yoshinobu Okumura, Machida-shi (JP); Kaoru Ojima, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/373,824

(22) PCT Filed: Oct. 10, 2007
(86) PCT No.: PCT/JP2007/071165

§ 371 Date: Jan. 14, 2009

(30) Foreign Application Priority Data
Oct. 27, 2006 (JP) 2006-293214
Sep. 21, 2007 (JP) 2007-246059

(51) Int. Cl. H01M 4/86; H01M 4/88

(52) U.S. Cl. 429/42; 29/623.5

(57) ABSTRACT

A water repellent catalyst layer for a polymer electrolyte fuel cell, including a water repellent coating film provided on catalyst particles, which are coated with a proton-conductive electrolyte, and a manufacturing method for a water repellent catalyst layer for a polymer electrolyte fuel cell including the steps of: coating catalyst particles with a proton-conductive electrolyte; providing a fluorine-based compound having at least one polar group and having a molecular weight of 10,000 or less on the catalyst particles to form a fluorine compound coating film; and imparting hydrophobic property by stabilizing the fluorine compound coating film. The hydrophobic property is imparted even to the inside of fine pores of the catalyst layer to improve water evacuation performance, so that an effective surface area and a catalyst utilization ratio can be increased.

### TECHNICAL FIELD

The present invention relates to a water repellent catalyst layer for a polymer electrolyte fuel cell and a manufacturing method for the water repellent catalyst layer.

### BACKGROUND ART

A fuel cell is a device for obtaining electric energy by supplying, as fuel, hydrogen, methanol, ethanol, or the like to an anode and oxygen or air to a cathode. With the fuel cell, clean power generation can be realized and high power generation efficiency can be obtained. Based on the electrolyte, fuel cells can be categorized as being of an alkaline type, a phosphate type, a molten carbonate type, a solid oxide type, or the like. Recently, attention has focused on polymer electrolyte fuel cells. A polymer electrolyte fuel cell has advantages such as ease of handling because it is operated at low temperature, ease of maintenance due to its simple structure, ease of pressurization control because a membrane can resist a differential pressure, and the ability to be reduced in size and weight because high output density can be obtained. Accordingly, the development of the polymer electrolyte fuel cell is an advance in a power source for automobiles and mobile equipment.

In the polymer electrolyte fuel cell, in general, a fluororesin-based ion exchange membrane is used as a solid electrolyte of a proton conductor, and a catalyst, such as platinum or platinum-alloy fine particles having high catalyst activation, is used for promoting a hydrogen oxidation reaction and an oxygen reduction reaction. The electrode reaction occurs in a so-called three-phase interface (electrolyte—catalyst electrode—fuel) in a catalyst layer. In this case, there is a problem in that a voltage is gradually reduced as power generation time elapses, and power generation finally stops. This is caused by a so-called “flooding phenomenon” in which water generated in the reaction is retained in spaces of the catalyst layer and the water fills the spaces in the catalyst layer, thereby inhibiting the supply of a fuel gas serving as a reactant. As a result, a power generation reaction stops. In particular, the flooding phenomenon is liable to occur in the catalyst layer on a cathode side, where the water is generated.

In order to prevent the flooding phenomenon, it is necessary to make the inside of the catalyst layer hydrophobic. There is a generally known method of mixing, with a catalyst layer including catalyst fine particles and a proton-conductive electrolyte, fluororesin-based particles, such as polytetrafluoroethylene (PTFE), together with a solvent or a surfactant. However, this method has a problem in that the three-phase interface is reduced due to the presence of the PTFE particles, so that output power is also reduced. Japanese Patent Application Laid-Open No. H05-036418 discloses a process in which platinum supported on acetylene black and Nafion (registered trademark) (manufactured by DuPont) are mixed with each other, crushed, and then mixed with PTFE particles, which are used as binding materials. However, in this method, when the PTFE particles are subjected to a glass transition, the Nafion (registered trademark) is decomposed, so an improvement in performance cannot be realized. As an example of an improvement of this process, Japanese Patent Application Laid-Open No. 2004-171847 discloses a method of imparting a distribution of a reaction area and a water repellent area in the cathode catalyst layer. Further, to impart a hydrophobic property to the smaller space, Japanese Patent Application Laid-Open No. 2001-076734 discloses a method of mixing a water repellent having a particle diameter of 10 μm or less.

However, hydrophobic particles as described above have no electronic or proton conductivity and are randomly mixed with a catalyst, an electrolyte, a catalyst-carrier, or the like, to be dispersed. As a result, even though the hydrophobic property of the catalyst layer using the hydrophobic particles is improved, there is a problem in that some of the hydrophobic particles enter a space between the catalyst and the electrolyte or between the catalyst fine particles, and an effective surface area decreases, thereby reducing a catalyst utilization ratio and catalyst layer performance.

Further, a diameter of the fluororesin-based hydrophobic fine particles conventionally used is about 100 nm to several μm, and a diameter of secondary aggregate particles is larger than that, that is, several μm to several tens of μm. Accordingly, there is a problem in that an inside of the space having a diameter smaller than 100 nm (hereinafter referred to as “micro space”) cannot be made hydrophobic in theory. In this case, the micro space remains hydrophilic. Accordingly, there is a problem in that when the outside of the micro space is made hydrophobic, the produced water is trapped in the micro space, stopping the reaction in the micro space, thereby reducing the catalyst utilization ratio.

Furthermore, the hydrophobic agent is in particulate form, so that when the size of the space and the size of the hydrophobic particles are substantially the same, there is a problem in that the space is filled by the hydrophobic particles, and the reaction in the space stops, thereby decreasing the catalyst utilization ratio.

As described above, in conventionally utilized techniques, there is a problem in that while the catalyst layer can be imparted with the hydrophobic property, the catalyst utilization ratio decreases. Accordingly, there is a need for a way to achieve both the hydrophobic modification of the catalyst layer and an increase in the catalyst utilization ratio.

### DISCLOSURE OF THE INVENTION

The present invention has been made in view of the above-mentioned problems, and it is an object of the present invention to provide a water repellent catalyst layer for a polymer electrolyte fuel cell, which imparts a hydrophobic property to entire space in a catalyst layer, including micro spaces, to improve the evacuation performance of the produced water and a catalyst utilization ratio, and a manufacturing method therefor.

Further, it is an object of the present invention to provide a polymer electrolyte fuel cell having the water repellent catalyst layer.

A water repellent catalyst layer for a polymer electrolyte fuel cell, which achieves the above-mentioned objects, includes a water repellent coating film provided on one of catalyst particles and catalyst-carrying particles, which are coated with a proton-conductive electrolyte.

The water repellent coating film desirably has a thickness of 50 nm or less.

The water repellent coating film desirably includes a fluorine-based compound having at least one polar group.

The fluorine-based compound desirably has a molecular weight of 10,000 or less.

A manufacturing method for a water repellent catalyst layer for a polymer electrolyte fuel cell, which achieves the above-mentioned objects, includes the steps of:

coating one of catalyst particles and catalyst-carrying particles with a proton-conductive electrolyte;

providing a fluorine-based compound having at least one polar group and having a molecular weight of 10,000 or less on one of the catalyst particles and the catalyst-carrying particles to form a fluorine compound coating film; and

imparting the hydrophobic property by stabilizing the fluorine compound coating film.

The step of providing the fluorine-based compound on one of the catalyst particles and the catalyst-carrying particles is desirably performed using a solution in which the fluorine-based compound having the molecular weight of 10,000 or less is dissolved in an organic solvent by one of an impregnation method, a spray method, a spin coating method, and a dip-coating method.

The step of imparting the hydrophobic property desirably includes one of a heat treatment at 200° C. or less, ultraviolet irradiation, and a plasma treatment.

A polymer electrolyte fuel cell, which achieves the above-mentioned objects, includes the water repellent catalyst layer described above.

According to the present invention, on a surface of the catalyst particles or of the catalyst-carrying particles coated with the proton-conductive electrolyte, there is provided the water repellent coating film including the fluorine compound having a molecular weight of 10,000 or less and including at least one polar group. As a result, there is provided the water repellent catalyst layer of a polymer electrolyte fuel cell, in which the water repellent film is formed on a surface of the proton-conductive electrolyte coating the catalyst particles, including the inside of the micro spaces, and the hydrophobic property is imparted to the catalyst layer, thereby improving the evacuation of the produced water. The water repellent coating film is a thin film made of a fluorine-based compound having a low molecular weight. Accordingly, the hydrophobic property can also be imparted to the inside of the micro space having a diameter of 100 nm or less, which has been difficult to do using conventional techniques. In addition, there is no risk of the micro space being filled.

Further, the present invention provides, at a low cost, a polymer electrolyte fuel cell, which uses a catalyst layer having improved evacuation performance of the produced water and which has a stable performance.

A more stable polymer electrolyte fuel cell can also be provided at a low cost.

Further, according to the present invention, the water repellent coating film is made of the fluorine-based compound having a molecular weight of 10,000 or less and including at least one polar group. The film thickness of the water repellent coating film is 50 nm or less, that is, extremely thin, thereby sufficiently allowing a fuel gas to pass therethrough. Accordingly, reduction in gas diffusibility and contact area between the catalyst and the electrolyte resulting from the hydrophobic property impartation, which has been a problem in conventional processes, can be eliminated. As a result, an effective surface area of the catalyst, which can contribute to a catalytic reaction, can be increased. Accordingly, the catalyst utilization ratio can be increased.

Therefore, the present invention enables both the hydrophobic modification and the increase of the catalyst utilization ratio at the same time, which is difficult to achieve using conventional methods. Further, by increasing the effective surface area of the catalyst, a catalyst-carrying amount can be reduced, so that the manufacturing cost can also be reduced.

Further, the present invention can provide, at a low cost, a polymer electrolyte fuel cell having stable power generation performance by using a catalyst having improved water evacuation performance, increased effective surface area, and increased catalyst utilization ratio. Also, the catalyst layer of the polymer electrolyte fuel cell can be produced simply, inexpensively, and in a highly reproducible manner using the manufacturing method according to the present invention.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a schematic diagram illustrating a single cell of a polymer electrolyte fuel cell.

FIG. 2 is a conceptual diagram illustrating an embodiment of a water repellent catalyst layer according to the present invention.

FIG. 3 is a conceptual diagram illustrating another embodiment of a water repellent catalyst layer according to the present invention.

FIG. 4 is a schematic diagram of an evaluation device for the polymer electrolyte fuel cell.

FIG. 5 is a graph illustrating properties of polymer electrolyte fuel cells according to Example 1 and Comparative Example 1 of the present invention.

FIG. 6 is an AFM image of a catalyst layer surface according to Comparative Example 2 of the present invention.

FIG. 7 is an AFM image of a catalyst layer surface according to Example 2 of the present invention.

FIG. 8 is an AFM image of a catalyst layer surface according to Example 3 of the present invention.

### BEST MODE FOR CARRYING OUT THE INVENTION

Hereinafter, the present invention will be described with reference to the drawings in more detail. Unless specifically stated, materials, dimensions, shapes, arrangements, and the like of this embodiment do not limit the scope of the present invention. The same applies to a manufacturing method described below.

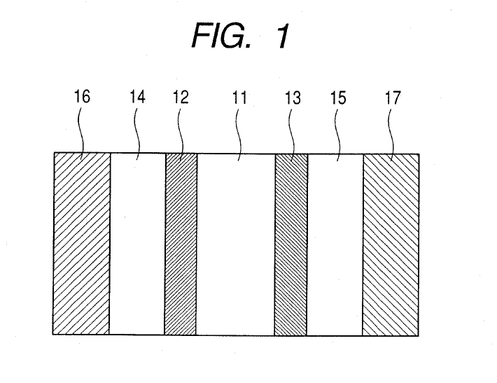

FIG. 1 is a schematic diagram illustrating an example of a sectional structure of a single cell of a polymer electrolyte fuel cell, which uses a water repellent catalyst layer for a polymer electrolyte fuel cell of the present invention. In FIG. 1, an anode catalyst layer 12 and a cathode catalyst layer 13 are arranged on opposite surfaces of a polymer electrolyte membrane 11, respectively.

On the outer sides of the anode catalyst layer and the cathode catalyst layer, there are arranged gas diffusion layers 14 and 15, respectively, and current collector plates 16 and 17, respectively.

The polymer electrolyte membrane 11 having high proton conductivity is needed to quickly move protons generated on an anode side to a cathode side. Specifically, as an organic group that can cause a dissociation of the protons, there are desirably used an organic polymer containing a sulfonic acid group, a sulfinic acid group, a carboxylic acid group, a phosphonic acid group, a phosphinic acid group, a phosphate group, a hydroxyl group, or the like. Examples of the above-mentioned organic polymer include a perfluorocarbon sulfonic acid resin, a polystyrene sulfonic acid resin, a sulfonated polyamide-imide resin, a sulfonated polysulfone acid resin, a sulfonated polyether imide semipermeable membrane, a perfluorophosphonic acid resin, and a perfluorosulfonic acid resin. An example of a perfluorosulfonic acid polymer includes Nafion (registered trademark) (manufactured by DuPont).

Further, necessary functions of the polymer electrolyte membrane include, in addition to the high proton conductivity, inhibition of unreacted reactant gases (hydrogen and oxygen) and mechanical strength. As long as those conditions are satisfied, any member can be selected to be used therefor.

In order to improve efficiency of the electrode reaction, the gas diffusion layer 14 or 15 uniformly and sufficiently supplies in plane a fuel gas or air to an electrode reaction region in the catalyst layer of a fuel electrode or air electrode. Further, the gas diffusion layers 14 and 15 functions to allow an electric charge generated by an anode electrode reaction to be conducted to the outside of the single cell and to efficiently release the produced water or the unreacted gas to the outside of the single cell. A porous body having electron conductivity, for example, a carbon cloth or carbon paper, may be desirably used as the gas diffusion layer.

The water repellent catalyst layer according to the present invention can be provided to one or each of the anode catalyst layer 12 and the cathode catalyst layer 13. Normally, in a fuel cell reaction, water is generated as a result of the reaction in the cathode catalyst layer 13. Therefore, the water repellent catalyst layer is desirably used for at least the cathode catalyst layer.

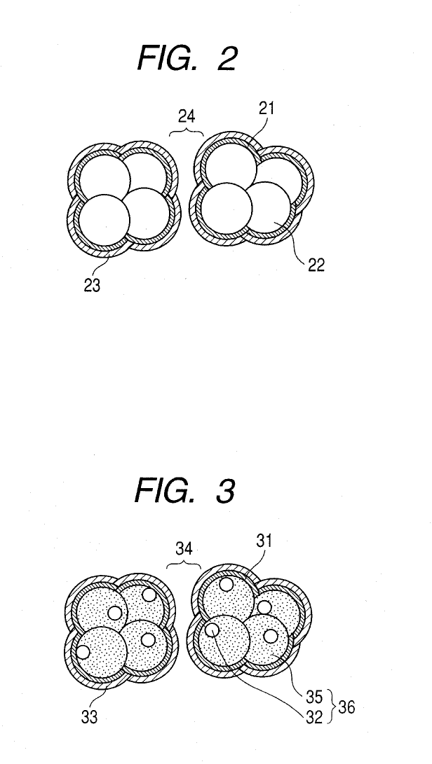

FIG. 2 is a schematic diagram illustrating an embodiment of the water repellent catalyst layer according to the present invention. As illustrated in FIG. 2, a water repellent coating film 23 is disposed on a surface of catalyst particles 22 coated with a proton-conductive electrolyte 21. An outermost surface of the catalyst layer including the catalyst particles 22 and the proton-conductive electrolyte 21 is covered by the water repellent coating film 23, thereby imparting the hydrophobic property to the catalyst layer without losing the proton conductivity of the catalyst layer. A micro space is denoted by reference numeral 24. The water repellent coating film 23 desirably covers a substantially entire area of the proton-conductive electrolyte 21. In this case, the substantially entire area is an area equal to or more than 90% of the surface of the proton-conductive electrolyte 21.

The water repellent coating film 23 according to the present invention is characterized by having a film thickness allowing sufficient transmission of the reactant gas. Specifically, the film thickness is desirably equal to or smaller than 50 nm. When the film thickness is larger than this value, there is a risk in that the supply of the reactant gas to a three-phase interface can be inhibited. However, when the film thickness of the water repellent coating film is equal to or smaller than 50 nm, the reactant gas is sufficiently transmitted. Accordingly, the hydrophobic property can be imparted to the catalyst layer without reducing a reaction surface area and a catalyst utilization ratio in the catalyst layer.

In order to impart the hydrophobic property to the catalyst layer, the water repellent coating film desirably has a thickness equal to or larger than 1 nm. Further, the thickness of the water repellent coating film is desirably equal to or smaller than 10 nm. More desirably, the thickness of the water repellent coating film is equal to or larger than 1 nm and equal to or smaller than 10 nm. Still more desirably, the thickness thereof is equal to or larger than 5 nm and equal to or smaller than 10 nm.

The thickness of the water repellent coating film as described above can also be controlled in the same manner. As a method of measuring the thickness, an SEM or TEM can be used to directly measure the thickness. Further, for the structure obtained by coating a flat Pt substrate, the thickness can be indirectly measured by various analytical methods (such as a step measurement, a surface roughness measurement, a minute shape measurement, a measurement using AFM, or a measurement using XPS).

Further, the water repellent coating film according to the present invention is formed of a fluorine-based compound having at least one polar group. Examples of the polar group include a hydroxyl group, an alkoxyl group, a carboxyl group, an ester group, an ether group, a carbonate group, and an amide group. Due to the polar group, the fluorine-based compound can be stabilized on the outermost surface of the catalyst layer. A part of the fluorine-based compound other than the polar group desirably has a structure including fluorine and carbon to obtain a good hydrophobic property and chemical stability. However, in a case where the part is sufficiently hydrophobic and chemically stable, the above-mentioned structure is not required.

Further, the water repellent coating film according to the present invention includes molecules of the fluorine-based compound having a molecular weight of 10,000 or less. When the molecular weight is larger than 10,000, it is difficult to make the inside of the micro space in the porous catalyst layer hydrophobic. Normally, in order to maximize the reaction surface area, the catalyst forming the catalyst layer includes catalyst particles or catalyst-carrying particles each having a particle diameter of several nm to several tens of nm, or a nano structural body formed of the catalyst particles. Therefore, the catalyst layer constitutes a porous body and has fine pores each having a diameter of several nm to several hundreds of μm. The fluorine-based compound having a low molecular weight is used as a precursor of the water repellent coating film, thereby enabling the formation of the water repellent coating film also on the inside of the fine pores each having the diameter of several nm to several hundreds of μm. The inside of the micro space is also made hydrophobic, so the catalyst utilization ratio is increased, thereby enabling driving with a high output power for a long time.

Further, the water repellent coating film according to the present invention is characterized in that the water repellent coating film has a film thickness allowing a sufficient transmission of the gas, is stabilized to the catalyst layer by the polar group, and can also make the inside of the minute fine pores hydrophobic due to its low molecular weight. Accordingly, a fine particle catalyst, a fine particle-carrying catalyst, a nano structural body catalyst, or the like, may be adopted irrespective of the size or the shape of the catalyst.

Examples of the fluorine-based compound having at least one polar group and having the molecular weight of 10,000 or less include perfluoro alcohol, perfluoro carboxylic acid, Demnum (manufactured by DAIKIN INDUSTRIES, Ltd.) used as a lubricating oil, surface treating agents, such as Krytox (manufactured by DuPont) and Novec EGC-1720 (manufactured by 3M). However, those are not necessary.

For the catalyst particles, a platinum oxide, a composite oxide of the platinum oxide and an oxide of a metallic element other than platinum, platinum obtained by performing a reduction treatment of the platinum oxide or the composite oxide, a multi-metal containing the platinum, a mixture of platinum and the oxide of the metallic element other than platinum, or a mixture of the multi metal containing platinum and the oxide of the metallic element other than platinum. The metallic element other than platinum is a metallic element of one or more kinds selected from the group consisting of Al, Si, Ti, V, Cr, Fe, Co, Ni, Cu, Zn, Ge, Zr, Nb, Mo, Ru, Rh, Pd, Ag, In, Sn, Hf, Ta, W, Os, Ir, Au, La, Ce, and Nd.

FIG. 3 is a conceptual diagram illustrating another embodiment of a water repellent catalyst layer according to the present invention. As illustrated in FIG. 3, a water repellent coating film 33 is disposed on a surface of catalyst carrying particles 36 coated with a proton-conductive electrolyte 31. A carrier is denoted by reference numeral 35 and a catalyst particle is denoted by reference numeral 32. Specifically, there is used one having a structure in which the catalyst is carried on a conductive material. Carbon is generally used as the conductive material, because carbon has excellent acid resistance. Carbon included in a catalyst-carrying carbon is not particularly limited. Examples of this carbon include carbon black, such as oil furnace black, channel black, lampblack, thermal black, or acetylene black, activated carbon, graphite, fullerene, carbon nanotube, and carbon fiber.

The shape of the catalyst particles or the catalyst-carrying particles is not limited, and may be, for example, a spherical shape, a wire shape, a tubular shape, or a rod shape. However, as long as the function as the catalyst is ensured, the shape is not limited thereto. It is desirable that an aggregate of the catalyst particles (for example, catalyst layer) form a porous body as described in the following examples. In order to form the catalyst layer constituting the porous body, it is desirable that the catalyst particle be a dendrite structural body. Further, a particle diameter of the catalyst particle is not limited. However, in order to increase a catalyst surface area and to enhance catalytic activity, the particle diameter is desirably 20 nm or less, and more desirably 10 nm or less. A lower limit value of an average particle diameter is not particularly limited. However, when the catalyst particle diameter is less than 1 nm, there is a problem in that agglomeration of the particles becomes conspicuous, so that a stable catalyst layer cannot exist, and a manufacturing process is difficult, thereby resulting in a high cost. Accordingly, the catalyst particle diameter is desirably equal to or larger than 1 nm.

For the proton-conductive electrolyte according to the present invention, for example, Nafion (registered trademark) (manufactured by DuPont) is used. However, as long as the electrolyte exhibits the proton conductivity as described above, the electrolyte is not limited thereto. As a method of forming the proton-conductive electrolyte layer on the surface of catalyst particles or catalyst-carrying particles according to the present invention, there is provided a mixing method that is normally performed at the time of manufacturing catalyst ink. Further, with regard to a thin-film catalyst, an impregnation method, a spray method, a spin coating method, a dip-coating method, or the like can be used. It is sufficient for the thickness of the proton conductive electrolyte to be in a range allowing a gas transmission. For example, the thickness is equal to or lower than 200 nm, preferably equal to or larger than 1 nm and equal to or smaller than 200 nm, and more preferably equal to or larger than 3 nm and equal to or smaller than 200 nm. When the thickness is larger than 200 nm, transmission of the gas is inhibited, and the gas cannot reach an interface between the catalyst surface and the electrolyte, so that the utilization ratio of the catalyst decreases, which is undesirable.

The thickness of the above-mentioned proton-conductive electrolyte can be controlled by controlling the concentration of an electrolyte solution and performing the coating several times. The thickness can be directly measured by the SEM or TEM. Further, for the structure obtained by performing the coating on the flat Pt substrate, the indirect measurement can be performed by various analytical methods (such as step measurement, surface roughness measurement, minute shape measurement, measurement using AFM, or measurement using XPS).

Various methods may be used to form the water repellent coating film according to the present invention. The optimum method includes the steps of: forming a coating film made of the fluorine compound having the low molecular weight at a film thickness of 50 nm or less; and stabilizing and making hydrophobic the coating film of the fluorine compound. While various coating methods can be adopted, any method by which the coating film can be provided at a thickness of 50 nm or less on the catalyst surface coated with the proton-conductive electrolyte may be used. Examples of the useful methods include a method of impregnating the catalyst layer with a solution in which the fluorine compound having the low molecular weight is dissolved in an organic solvent and the dip-coating method in which the catalyst layer is put into the above-mentioned solution and the catalyst layer is then raised at a constant speed. A method of forming the film of a particulate water repellent material, such as PTFE particles, on the surface of the electrolyte can result in the decomposition of the electrolyte in the processes from glass transition to melting. Thus, a different method is desirable.

Further, the step of stabilizing and making hydrophobic the coating film of the fluorine compound is a process of stabilizing the coating film such that the fluorine compound does not decompose or melt due to, for example, driving of the fuel cell for a long time or generation of the water, thereby improving stability and the hydrophobic property. As a specific processing method, there are provided a heat treatment at 200° C. or less in air or an inert gas, ultraviolet irradiation, and a plasma treatment. It is necessary for those treatments to be performed without loosing the proton conductivity of the proton-conductive electrolyte. For example, in a case of using Nafion (registered trademark) for the proton-conductive electrolyte, as heat treatment conditions, in an atmosphere or an inert gas, a temperature of 200° C. or less is desirable, and a temperature of 150° C. or less is more desirable. A lower limit of the heat treatment temperature is a temperature at which a solvent, in which the fluorine compound is dissolved, can be completely evaporated. Depending on the solvent, the temperature may be room temperature, so the temperature is not limited.

In FIGS. 2 and 3, the micro space 24 and a micro space 34 are formed, respectively. The micro space means a space, which PTFE particles cannot enter, the PTFE particle being a conventional water repellent (hydrophobic modification is impossible using PTFE particles). The micro space is desirably smaller than the diameter of the PTFE particles. Therefore, the size of the micro space, in particular, the lower limit value thereof, is not necessarily limited, and an upper limit value may be about 100 nm, which is a lower limit of the diameter of the general PTFE particle.

On the anode side, a fuel for the polymer electrolyte fuel cell may be any fuel, which generates electrons and protons, such as hydrogen, reformed hydrogen, methanol, dimethyl ether, or the like. On the cathode side, the fuel may be any fuel, which receives protons and electrons, such as air, oxygen, or the like. It is suitable, in view of reaction efficiency and practical use, that hydrogen or methanol be used on the anode side and air or oxygen be used on the cathode side.

Next, specific examples will be illustrated to describe the present invention. However, the present invention is not limited to those examples.

### Example 1

In this example, a description is made of an example in which, by a reactive sputtering method, a porous platinum oxide was formed and was reduced to form a porous platinum catalyst. After that, a coating film was formed by using Novec EGC-1720 (manufactured by 3M) and was then irradiated with ultraviolet light, thereby manufacturing a water repellent catalyst layer.

On a PTFE sheet (NITOFLON manufactured by Nitto Denko Corporation), a porous platinum oxide layer was formed by the reactive sputtering method to have a thickness of 2 μm. The reactive sputtering was performed under conditions of a total pressure of 5 Pa, an oxygen flow rate of (QO₂/(QAr+QO₂)) 70%, a substrate temperature of 25° C., and an RF input power of 5.4 W/cm². On the obtained porous platinum oxide layer, 50 μl of a 5 wt. % Nafion (registered trademark) solution (manufactured by Wako Pure Chemical Industries, Ltd.) was dropped and a solvent was evaporated in a vacuum, thereby forming an electrolyte channel on a surface of the porous platinum oxide catalyst.

Porous platinum oxide catalyst sheets were cut out to have a predetermined area and were arranged on both surfaces of a Nafion (registered trademark) membrane (N112 manufactured by DuPont). Hot pressing (8 MPa, 150° C., 10 minutes) was performed with respect thereto to remove the PTFE sheet, thereby obtaining a porous platinum oxide membrane electrode assembly. Successively, the obtained membrane electrode assembly was subjected to a reduction treatment for 30 minutes in a 2% H₂/He atmosphere under a pressure of 0.1 MPa, thereby obtaining a porous platinum membrane electrode assembly. In this case, the platinum loading was about 0.6 mg/cm².

In this case, the porous platinum membrane had a dendritic shape. This point was the same in all of the following examples and comparative examples.

The porous platinum membrane electrode assembly obtained as described above was coated with the Novec EGC-1720 by a dip-coating method, thereby forming a water repellent coating film. After that, UV irradiation was performed for 10 minutes, thereby stabilizing and making hydrophobic the water repellent coating film.

### Comparative Example 1

A membrane electrode assembly obtained in the same manner as in Example 1 was provided, except that the coating with the Novec EGC-1720 and the UV irradiation were omitted.

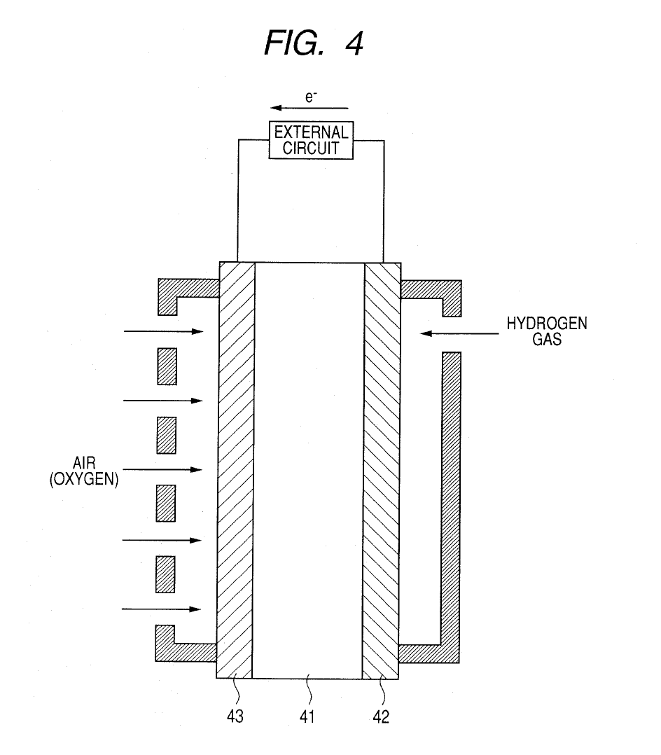

Carbon cloths (LT1400-W manufactured by E-TEK) were arranged on both surfaces of the membrane electrode assembly manufactured by the above-mentioned steps, and a single cell having a structure illustrated in FIG. 4 was formed to perform an electrochemical evaluation. An anode electrode side had a dead end mode to thereby be charged with a hydrogen gas, and a cathode electrode side was released to air thereby performing an electric discharge test under an external environment of a temperature of 25° C. and a relative humidity of 50%. A membrane electrode assembly is denoted by reference numeral 41, an anode side electrode is denoted by reference numeral 42, and a cathode side electrode is denoted by reference numeral 43.

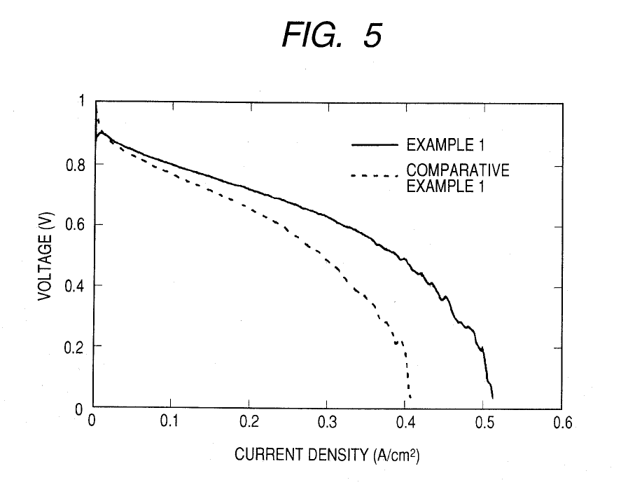

FIG. 5 illustrates I-V curves according to Example 1 and Comparative Example 1. When a comparison is made therebetween, in Example 1, while high performance is exhibited in almost the entire current density region, excellent performance is exhibited particularly in a high current density region. This is probably due to the water evacuation performance being improved by the water repellent coating film provided to the catalyst layer.

In order to check a coating state of the water repellent coating film formed on the catalyst layer surface made of electrolyte and porous platinum, an atomic force microscope (AFM) was used to perform the analysis. An analytical sample was manufactured by the following procedures.

### Example 2

In this example, a description is made of an example in which, by the reactive sputtering method, the electrolyte layer was formed on the porous platinum oxide, and after that, the coating film was formed by using a 10-fold dilution of Novec EGC-1720 (manufactured by 3M) and was irradiated with ultraviolet light, thereby manufacturing the water repellent catalyst layer as an AFM analytical sample.

In the same manner as in Example 1, the porous platinum oxide layer was formed on the PTFE sheet (NITOFLON manufactured by Nitto Denko Corporation) by the reactive sputtering method to have a thickness of 2 μm. On the obtained porous platinum oxide layer, 50 μl of the 5 wt % Nafion (registered trademark) solution (manufactured by Wako Pure Chemical Industries, Ltd.) was dropped and dried, thereby forming the electrolyte layer on the surface of the porous platinum oxide layer.

The obtained sample was coated by the dip-coating method with the Novec EGC-1720 diluted 10-fold with an HFE-7100 (manufactured by 3M) as a solvent, thereby forming a water repellent coating film. After that, the UV irradiation was performed for 10 minutes, thereby stabilizing and making hydrophobic the water repellent coating film.

### Example 3

In this example, a water repellent catalyst layer was manufactured, as an AFM analytical sample, in the same manner as in Example 2, except that the Novec EGC-1720 according to Example 2 was used without being diluted.

### Comparative Example 2

A catalyst layer obtained in the same manner as in Example 2 was provided, except that the coating with the Novec EGC-1720 and the UV irradiation was omitted.

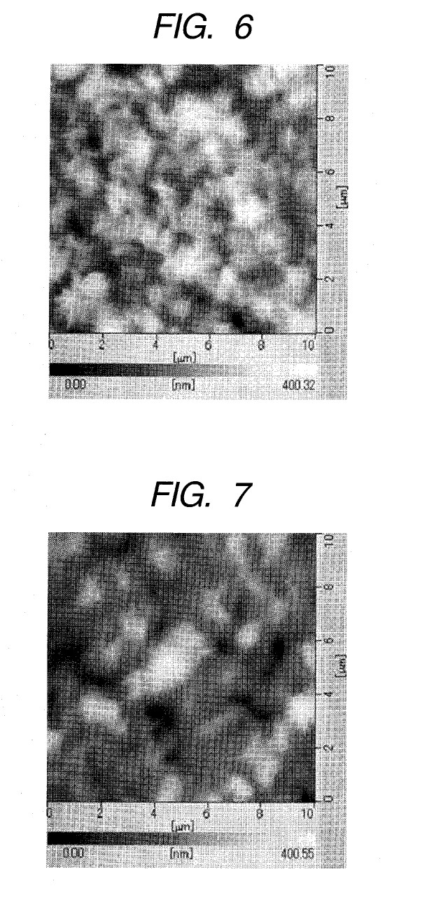

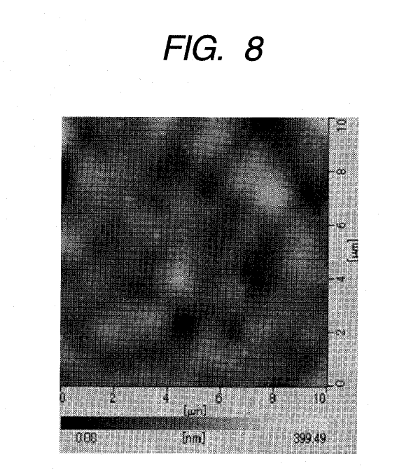

FIG. 6 illustrates an AFM image according to Comparative Example 2. As illustrated in FIG. 6, a mode of the porous platinum oxide was observed. With reference to FIG. 6, it is assumed that the electrolyte layer is uniformly formed on the porous platinum oxide surface. FIGS. 7 and 8 illustrate AFM images according to Examples 2 and 3, respectively. It is understood that, by forming the water repellent coating film on the electrolyte, the mode of the porous platinum oxide observed in FIG. 6 is caused to be gradually unclear (FIG. 7). Further, in Example 3 in which the water repellent coating film is formed by using a solution of a higher concentration, the mode of the porous platinum oxide serving as a base becomes almost invisible (FIG. 8). In Comparative Example 2 and Examples 2 and 3, average surface roughness (Ra) was 49.3 nm, 46.9 nm, and 31.6 nm, respectively. By forming the water repellent coating film, surface irregularities due to the porous platinum oxide are smoothed. By adhering more of the water repellent coating film (forming water repellent coating film by using a solution of a higher concentration), the surface roughness is further reduced. Thus, the water repellent coating film is formed so as to cover a substantially entire area of the catalyst layer surface.

Further, from FIGS. 7 and 8, it is understood that the water repellent coating film formed so as to cover the substantially entire area is partially deposited in a protrusion form. It is understood that heights of the protruding deposits are about 20 nm to 30 nm and there are more protruding deposits in FIG. 8 than in FIG. 7.

### Example 4

In this example, a description is made of an example in which after the porous platinum catalyst was formed in the same manner as in Example 1, a coating film was formed by using the Novec EGC-1720 (manufactured by 3M) and was subjected to a heat treatment, thereby manufacturing a water repellent catalyst layer.

Example 4 provided a membrane electrode assembly obtained in the same manner as in Example 1, except that the UV irradiation process with respect to the Novec EGC-1720 was changed to a heat treatment at 150° C. for 10 minutes.

In the same manner as in Example 1, the single cell illustrated in FIG. 4 was used to evaluate fuel cell performances according to Example 4 and Comparative Example 1. A comparison was made between reduction ratios of maximum current density due to the repetitive measurement of the I-V sweep. In this case, the reduction ratio of the maximum current density indicates a degree of reduction of the maximum current density of a fourth I-V sweep with respect to a first I-V sweep. While in Comparative Example 1 a reduction of about 47% was observed, in Example 2, a reduction of only about 14% was observed. Similar to Example 1, this is probably due to the water evacuation performance being improved by the water repellent coating film provided to the catalyst layer.

### Example 5

In this example, a description is made of an example in which a platinum black catalyst layer was formed, and the coating film was formed thereon by using the Novec EGC-1720 (manufactured by 3M). After that, a heat treatment was performed with respect thereto, thereby manufacturing a water repellent catalyst layer.

Predetermined amounts of platinum black (HiSPEC1000 manufactured by Johnson Matthey), the Nafion (registered trademark) solution (5 wt. %, manufactured by Wako Pure Chemical Industries, Ltd.), isopropyl alcohol (IPA), and water were mixed with each other. After that, the resultant was sufficiently stirred and dispersed to thereby manufacture a slurry. On the PTFE sheet (NITOFLON manufactured by Nitto Denko Corporation), the slurry was applied to have a predetermined thickness by using a doctor blade method and was sufficiently dried, thereby obtaining a catalyst layer.

Parts were cut out from the catalyst layer to have a predetermined area and were arranged on both surfaces of the Nafion (registered trademark) membrane (N112 manufactured by DuPont), the hot press was performed (8 MPa, 150° C., 10 minutes), and the PTFE sheet was removed, thereby obtaining a platinum black membrane electrode assembly. In this case, the platinum loading was about 5.0 mg/cm².

The platinum black membrane electrode assembly obtained as described above was subjected to the dip-coating method in the Novec EGC-1720 for coating on the catalyst layer surface, thereby forming a water repellent coating film.

After the membrane electrode assembly coated with the Novec EGC-1720 was sufficiently dried, a heat treatment was performed at 150° C. for 10 minutes, thereby stabilizing and making hydrophobic the water repellent coating film.

### Comparative Example 3

A membrane electrode assembly obtained in the same manner as in Example 5 was provided, except that the coating with the Novec EGC-1720 and the heat treatment were omitted.

In the same manner as in Example 1, the single cell illustrated in FIG. 4 was used to evaluate fuel cell performances according to Example 5 and Comparative Example 3. Similar to Example 2, a comparison was made between reduction ratios of maximum current density due to the repetitive measurement of the I-V sweep. While in Comparative Example 3 a reduction of about 8% was observed, in Example 5, a reduction of only about 4% was observed. As in Example 1, this is probably due to the water evacuation performance being improved by the water repellent coating film provided to the platinum black catalyst layer.

According to the preferred embodiment of the present invention, the water repellent catalyst layer for a polymer electrolyte fuel cell, which has the improved evacuation performance of the product water in the catalyst layer and the improved catalyst utilization ratio, can be provided.

Further, according to the preferred embodiment of the present invention, by using the water repellent catalyst layer imparted with the above-mentioned hydrophobic property, the polymer electrolyte fuel cell having stable power generation performance can be provided at a low cost.

Further, the polymer electrolyte fuel cell having the catalyst layer according to the preferred embodiment of the present invention can be used as a fuel cell for small electronic equipment, such as a mobile phone, a notebook personal computer, or a digital camera.

This application claims priority from Japanese Patent Application Nos. 2006-293214, filed Oct. 27, 2006, and 2007-246059, filed Sep. 21, 2007, which are hereby incorporated herein by reference.

1. A water repellent catalyst layer for a polymer electrolyte fuel cell, comprising a water repellent coating film provided on one of catalyst particles and catalyst-carrying particles which are coated with a proton-conductive electrolyte.

2. The water repellent catalyst layer for a polymer electrolyte fuel cell according to claim 1, wherein the water repellent coating film has a thickness of 50 nm or less.

3. The water repellent catalyst layer for a polymer electrolyte fuel cell according to claim 1, wherein the water repellent coating film includes a fluorine-based compound having at least one polar group.

4. The water repellent catalyst layer for a polymer electrolyte fuel cell according to claim 3, wherein the fluorine-based compound has a molecular weight of 10,000 or less.

5. A manufacturing method for a water repellent catalyst layer for a polymer electrolyte fuel cell, comprising the steps of:
coating one of catalyst particles and catalyst-carrying particles with a proton-conductive electrolyte;
providing a fluorine-based compound having at least one polar group and having a molecular weight of 10,000 or less on one of the catalyst particles and the catalyst-carrying particles to form a fluorine compound coating film; and
imparting hydrophobic property by stabilizing the fluorine compound coating film.

6. The manufacturing method for a water repellent catalyst layer for a polymer electrolyte fuel cell according to claim 5, wherein the step of providing the fluorine-based compound on one of the catalyst particles and the catalyst-carrying particles is performed using a solution in which the fluorine-based compound having the molecular weight of 10,000 or less is dissolved in an organic solvent, by one of an impregnation method, a spray method, a spin coating method, and a dip-coating method.

7. The manufacturing method for a water repellent catalyst layer for a polymer electrolyte fuel cell according to claim 5, wherein the step of imparting the hydrophobic property comprises one of a heat treatment at 200° C. or less, ultraviolet irradiation, and a plasma treatment.

8. A polymer electrolyte fuel cell, comprising the water repellent catalyst layer according to claim 1.
